(19) United States
(12) Patent Application Publication
(10) Pub. No.: US 2007/0075986 A1
(43) Pub. Date: Apr. 5, 2007

(54) Proximity sensing device and sensing method thereof

(75) Inventor: Chun-Hsiung Chen, Hsinchu City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Holtek Semiconductor Inc., Hsinchu City (TW)

(21) Appl. No.: 11/542,407

(22) Filed: Oct. 3, 2006

(30) Foreign Application Priority Data
Oct. 5, 2005 (TW) 094134879

(51) Int. Cl. G09G 5/00

(52) U.S. Cl. 345/173

(57) ABSTRACT

A proximity sensing device for judging an operation is provided. The proximity sensing device includes a first sensing area sensing the operation and generating a first signal; and a second sensing area sensing the operation and generating a second signal, wherein if a ratio of the first signal and the second signal is greater than a threshold, the operation is judged as a correct operation.

### FIELD OF THE INVENTION

The present invention relates to a switch device, in particular, to a proximity sensing device and the sensing method of a switch device.

### BACKGROUND OF THE INVENTION

With a speedy improvement of the optoelectronics technology, the demands for the proximity sensing transfer switch have been broadly increased. The frequently used switching devices include the proximity switch and the touch panel, which are mainly applied to switch the status of the system. Typically, for a proximity detector, it is operated as follows: when an object approaches the sensing range of the detector, the detector senses the position of the object and transfers the location information to the operating system. The system or the machines will response to the information with a proper action, in order to achieve the purpose of switching the status of the system.

Take the touch panel for example, a sensing unit is affiliated to the display device and cooperates mutually with both the controlling circuit and the equipment driving software, so as to detect every external motion as well as confirm the exact position of the motion and further send the mentioned information to the computer operating system. Conventionally, the sensing schemes frequently adopted in the proximity detector include an electric field scheme, an electric resistance scheme, an electric capacitance scheme, a sound wave and an optic scheme etc.

The electric field scheme is termed as the Near Field Imaging (NFI) technique as well. The panel adopted in the scheme utilizes two laminated transparent glasses and one single layer of the transparent metal oxide conductive coating is covered thereon. The alternate signal is applied to the conductive coating and a static electricity field is developed around the surface of the display device. When fingers (with gloves or not) or objects approach and contact the detector, the static electricity is interfered and varied by the external disturbances. The cooperating imaging processor detects the interfering signals and the positions thereof and transmits the corresponding coordinate parameters to the operating system. The NFI panel is quite durable with high sensitivity and is able to be used in an extremely harsh environment.

The electric resistance touch panel constitutes of a soft upper board and a hard lower board, and a few insulating spots spread therebetween. One layer of the transparent metal oxide conductive coating is coated between the inner sides of the upper and lower boards. Due to the fractional voltage effect, the spots located at different positions of the board have different electricity magnitude. If one touches the upper board, a contact point connecting both the upper board and the lower board is provided. The work methodology thereof is analogized to the transfer switch in the electric circuit. The controlling circuit will transform the voltage difference into the relevant coordinate information. The requirement of the power supply for the electric resistance touch panel is simply gratified, so that the electric resistance touch panel is highly feasible to be commercialized and is widely applicable to all technical fields. However, the surface thereof is fabricated by the plastic that is unduly soft and possesses a poor wear-resisting character.

The electric capacitance touch panel constitutes of a curve glass or a plat glass coating with the transparent metal oxide over the surface thereon. Then a voltage is applied to the respective four comers of the panel. When fingers with no grove or conductors contact the panel, the electric current will be absorbed thereby and a refreshed electric field is developed over the panel surface. Typically the magnitude of the electric current alters in response to the position being touched. The controlling circuit determines the coordinates where the touch exactly occurs according to the magnitude of the electric current. The electric capacitance touch panel is mainly used for the entertainment industry and the information service equipment for the public domain. The panel does not affect the clarity to the display that bears excellent sensitivity. Nevertheless, the shortage of the electric capacitance touch panel is that it needs the frequent calibration whose performance is easily affected by the long-term use due to the friction.

The sound wave scheme touch panel emits the supersonic wave from the vertical and lateral frames around the edges of the panel. The plural supersonic detectors are disposed along the opposite frame to the mentioned frame. An intact supersonic wave grille is formed on the surface of the display device after the supersonic wave is initiated. When fingers or other soft stylus approach the surface of the display, the supersonic wave is diffracted and absorbed thereby. The supersonic detector is used for analyzing whether the fingers or the soft stylus meet the panel. The different supersonic detector represents the different position on the coordinate. The controlling circuit is able to mark the contacting point according to the information regarding the variation as to the strength and the location of the supersonic wave. The resolution of the panel is fine and the panel is durable for long-term use. An additional feature for the panel is that the requirement for the plainness of the surface is not strict, so that it is highly compatible with the spherical-surface and the cylindrical surface monitors. Nevertheless, the drawbacks thereof are that fingers or stylus must be absorbable for the supersonic wave, which amounts to be accessibly interfered by other surrounding noises. Furthermore, the demands for the power supply system and for the clearness of the panel surface are high standard. Jointly, the water or oil droplet and the ash will also influence the performance of the panel.

The infrared ray touch panel is operated on the basis of the so-called light beam blockage technique. It does not need to coat any extra material on the surface of the original monitor, but alternatively needs to settle a framework along the edge of the monitor. For a couple of the mutual opposite frames, multiple LEDs (Light Emitting Diode) are disposed on one of the frames thereof and on the opposite frame, multiple infrared detectors are disposed (similar to the mentioned sound wave touch panel). An intact infrared ray grille is constructed over the surface of the monitor. When objects enter the grille, the infrared ray is obstructed. The infrared ray detectors immediately receive the varied signal and the controlling circuit transfers the coordinate information regarding the touch points to the operating system. The advantage of the infrared ray panel is that it is completely previous to light and therefore the clearness of the displayer is not influenced, leading to the superior resolution. However, the defects are that the price thereof is higher and the life of the diode is shorter, and further the panel is easily interfered by the strong light.

The structure and the working principle of the proximity transfer switch are approximately identical with that of the aforementioned touch panel. The only discrepancy is that for the switch, the sensing device is disposed at the switch body for directly sensing an operation.

To sum up, the working principles of the current proximity sensing device are classified into five major categories such as an electric field scheme, an electric resistance scheme, an electric capacitance scheme, a sound wave scheme and an optic scheme. The mentioned schemes used to perform the detection aim to a specific point or to a specific region. But comprehensively, no matter which proximity sensing device is adopted in the practical occasion, the following predicaments inevitably occur: (1) the essential design of the proximity device has to be varied in correspondence with the external environment; (2) the sensitivity thereof is altered in accordance with the environment; (3) the electric interference from other electric fields is inevitable; and (4) the mistaken operation is frequently arisen. Based upon the mentioned reasons, though the touch panel and the proximity sensor have been developed for a long time, these devices are still not extensively popularized.

To overcome the mentioned drawbacks existing in the prior art, a proximity sensing device and the sensing method thereof are provided.

### SUMMARY OF THE INVENTION

According to the first aspect of the present invention, a proximity sensing device for judging an operation is provided. The proximity sensing device includes a first sensing area sensing the operation and generating a first signal; and a second sensing area sensing the operation and generating a second signal, wherein if a ratio of the first signal and the second signal is greater than a threshold, the operation is judged as a correct operation.

According to the second aspect of the present invention, a proximity sensing device for judging an operation is provided. The proximity sensing device includes a first sensing area and plural second sensing areas sensing the operation and generating a first signal and plural second signals respectively, wherein if a ratio of the first signal and any one of the plural second signals is greater than a threshold, the operation is judged as a correct operation.

According to the third aspect of the present invention, a proximity sensing method for judging whether an operation is a correct operation is provided. The proximity sensing method includes steps of: generating a first signal in response to the operation; generating a second signal in response to the operation; and if a ratio of the first signal and the second signal is greater than a threshold, judging the operation as a correct operation.

The foregoing and other features and advantages of the present invention will be more clearly understood through the following descriptions with reference to the drawings:

### BRIEF DESCRIPTION OF THE DRAWINGS

FIG. 1 is a diagram in vertical view illustrating a first preferred embodiment of the proximity sensing device in the present invention;

FIG. 2(a) is a diagram in vertical view illustrating a second preferred embodiment of the proximity sensing device in the present invention;

FIG. 2(b) is a diagram in vertical view illustrating a modified second preferred embodiment of the proximity sensing device in the present invention; and

FIG. 3 is a diagram in vertical view illustrating a third preferred embodiment of the proximity sensing device in the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the aspects of illustration and description only; it is not intended to be exhaustive or to be limited to the precise form disclosed.

The First Preferred Embodiment.

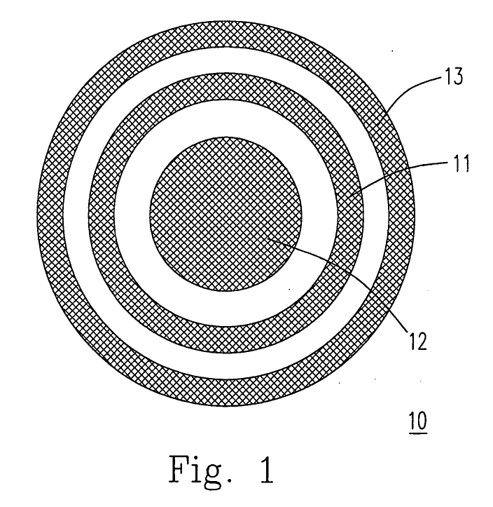

Please refer to FIG. 1, which is a diagram in vertical view illustrating a first preferred embodiment of the proximity sensing device in the present invention. The proximity sensing device 10 demonstrated in FIG. 1 includes a driving area 11, an active sensing area 12 and a restrictive sensing area 13. The first preferred embodiment is an electric field type of the proximity sensing device, wherein the driving area 11 is used for generating an electric field. When an electric field is generated by the driving area 11, the active sensing area 12 and the restrictive sensing area 13 both detect a fundamental voltage. When there is no operation provided, the active sensing area 12 and the restrictive sensing area 13 detect the same electric voltage in magnitude. The active sensing area 12 is used for detecting an operation (a motion), and a first voltage variation is generated therefrom. The restrictive sensing area 13 is used for detecting the operation, and a second voltage variation is generated therefrom. It is noted that the active sensing area 12 is regarded as the first sensing area and the restrictive sensing area 13 is regarded as the second sensing area, while the active sensing area 12 is regarded as the second sensing area and the restrictive sensing area 13 is able to be regarded as the first sensing area.

In the first preferred embodiment, essentially the active sensing area 12 is designed to detect the operation being a correct operation. In contrast, the restrictive sensing area 13 is designed to detect the operation being a mistaken operation. It is repeatedly noted (as aforementioned) that the respective functions of the active sensing area 12 and the restrictive sensing area 13 are possibly interchangeable with each other. That is, the active sensing area 12 can be altered to be used to generate the second voltage variation, namely to detect the mistaken operation, while the restrictive sensing area 13 can be altered to be used to generate the first voltage variation, namely to detect the correct operation.

For the present preferred embodiment, the proximity sensing device distinguishes whether an operation is a correct operation as follows:

When an operation precisely lands on the active sensing area 12, the first voltage variation is generated due to the operation detected by the active sensing area 12; however, the same operation is not detected by the restrictive sensing area 13, and therefore the second voltage variation is not generated. If a ratio of the first voltage variation and the second voltage variation is greater than a threshold, the operation is judged as a correct operation.

When a large-area mistaken operation lands on the active sensing area 12, simultaneously it lands on the restrictive sensing area 13 as well. The active sensing area 12 and the restrictive sensing area 13 detect the large-area mistaken operation, and the first voltage variation and the second voltage variation are respectively generated. If the ratio of the first voltage variation and the second voltage variation is not over a threshold, the operation is judged as a mistaken operation.

When an operation directly lands on the restrictive sensing area 13, the second voltage variation is generated due to the operation detected by the restrictive sensing area 13; however, the same operation is not detected by the active sensing area 12, and therefore the first voltage variation is not generated. If a ratio of the first voltage variation and the second voltage variation is not over a threshold, the operation is judged as a mistaken operation.

If an object whose contact area is smaller than that of the active sensing area 12 lands on the active sensing area 12, such as ash, water droplet, oil droplet and stains etc, the first voltage variation is not generated since the object is too tiny to be detected by the active sensing area 12. In this respect, the same object is not detected by the restrictive sensing area 13 and therefore the second voltage variation is not generated. Hence, the ratio of the first voltage variation and the second voltage variation is not over a threshold, and the operation induce by the object is judged as a mistaken operation.

The default value of the mentioned threshold value is set as 7/3 (first voltage:second voltage=7:3) as a preferred value; however, the threshold value is adjustable. The user can predefine the threshold value according to different circumstances. If the higher value of the threshold is defined, the sensitivity of the proximity is dull (low sensitivity) and if the lower value of the threshold is defined, the sensitivity of the proximity is sharp (high sensitivity).

Based upon the aforementioned description, it is understood that when the aforementioned proximity sensing device is working, the active sensing area 12 and the restrictive sensing area 13 are not connected with each other in formality, which is also not limited to the specific relative location arrangement. For example, there are several possible arrangement patterns between the active sensing area 12 and the restrictive are 13, which include that the active sensing area 12 and the restrictive sensing area 13 are adjacent to each other, the active sensing area 12 is surrounded by the restrictive sensing area 13, and the restrictive sensing area 13 is surrounded by the active sensing area 12. However, please be noted that the possible combination for the arrangement patterns is numerous and is not limited to the mentioned disclosure.

Furthermore, the respective shapes of the active sensing area 12 and the restrictive sensing area 13 are also not limited to a specific shape. Each of the active sensing area 12 and the restrictive sensing area 13 is possibly in a shape of circle, rectangle, ellipse, star, heart, hollow-shape or any other shape as required. However, please be noted that the possible shapes of the active sensing area 12 and the restrictive sensing area 13 are various, which are not limited to the mentioned disclosure.

In the first preferred embodiment, either of the active sensing area 12 and the restrictive sensing area 13 detects the operation through an electric field scheme, an electric resistance scheme, an electric capacitance scheme, a sound wave or an optic scheme. However, the active sensing area 12 is allowed to detect the operation in a way different from that of the restrictive sensing area 13. For example, the active sensing area 12 adopts the electric field scheme to detect the operation, but the restrictive sensing area 13 adopts the sound wave scheme to detect it. Please be noted that the possible combinations to arrange the scheme are numerous, which are not limited to the mentioned disclosure.

The Second Preferred Embodiment.

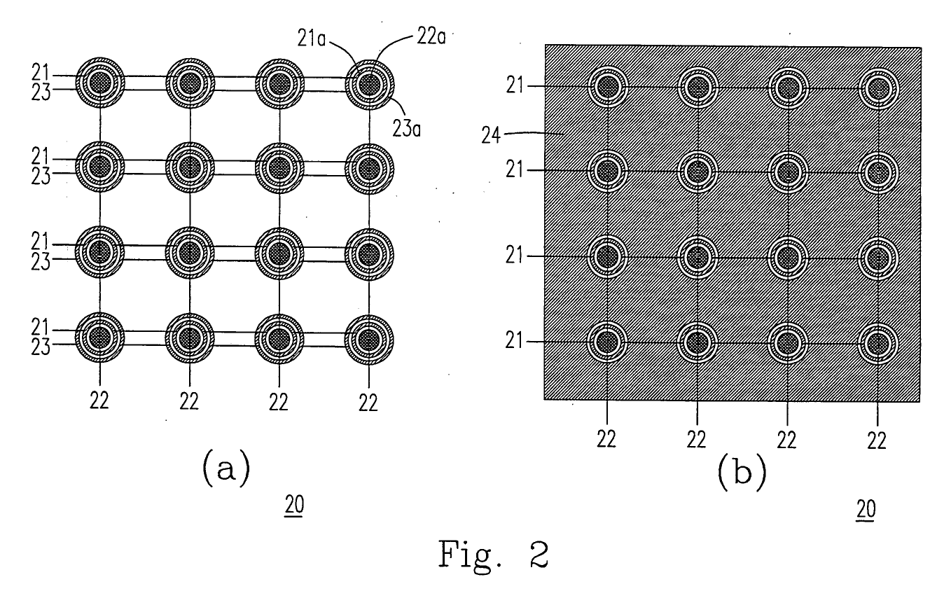

Please refer to FIG. 2(a), which is a diagram in vertical view illustrating a second preferred embodiment of the proximity sensing device in the present invention. The proximity sensing device 20 demonstrated in the FIG. 2(a) includes plural driving areas 21, plural active sensing areas 22 and plural restrictive sensing areas 23. The second preferred embodiment is an electric field type of the proximity sensing device, wherein the plural driving areas 21 are used for generating an electric field. When an electric field is generated by the plural driving areas 21, the plural active sensing areas 22 and the plural restrictive sensing areas 23 both detect a fundamental voltage. When there is no operation provided, the plural active sensing areas 22 and the plural restrictive sensing areas 23 detect the same electric voltage in magnitude. The plural active sensing areas 22 are used for detecting an operation (a motion), and plural first voltage variations are generated therefrom. The plural restrictive sensing areas 23 are used for detecting the operation, and plural second voltage variations are generated therefrom. It is noted that the plural active sensing areas 22 are regarded as the plural first sensing areas and the plural restrictive sensing areas 23 are regarded as the plural second sensing areas, while the plural active sensing areas 22 are regarded as the second sensing areas and the plural restrictive sensing areas 23 are able to be regarded as the first sensing areas.

Please refer to FIG. 2(b), which is a diagram in vertical view illustrating a modified second preferred embodiment of the proximity sensing device in the present invention. The proximity sensing device 20 demonstrated in FIG. 2(b) includes plural driving areas 21, plural active sensing areas 22 and a restrictive sensing area 24, wherein the plural restrictive sensing areas 23 illustrated in FIG. 2(a) are combined as the restrictive sensing area 24. The plural driving areas 21 are used for generating an electric field. When an electric field is generated by the plural driving areas 21, the plural active sensing areas 22 and the restrictive sensing area 24 both detect a fundamental voltage. When there is no operation provided, the plural active sensing areas 22 and the restrictive sensing area 24 detect the same electric voltage in magnitude. The plural active sensing areas 22 are used for detecting an operation (a motion), and plural first voltage variations are generated therefrom. The restrictive sensing area 24 is used for detecting the operation, and plural second voltage variations are generated therefrom. It is noted that the plural active sensing areas 22 are regarded as the plural first sensing areas and the restrictive sensing area 24 are regarded as the plural second sensing areas, while the plural active sensing areas 22 are regarded as the second sensing areas and the restrictive sensing area 24 are able to be regarded as the first sensing areas.

In both second preferred embodiments, essentially the plural active sensing areas 22 are designed to detect the operation being a correct operation. In contrast, the plural restrictive sensing areas 23, 24 are designed to detect the operation being a mistaken operation. It is repeatedly noted (as aforementioned) that the respective functions of the plural active sensing areas 22 and the plural restrictive sensing areas 23 are possibly interchangeable with each other. That is, the plural active sensing areas 22 can be altered to be used to generate the plural second voltage variations, namely to detect the mistaken operation, while the plural restrictive sensing areas 23 can be altered to be used to generate the plural first voltage variations, namely to detect the correct operation.

With respect to the distinguishing method, the default value of the threshold value, the relative location arrangement, the shapes of the plural driving areas 21, the plural active sensing areas 22 and the plural restrictive sensing areas 23, 24, and the detecting method adopted in both second preferred embodiments, all of the principles are identical to those described in the first preferred embodiment.

The Third Preferred Embodiment.

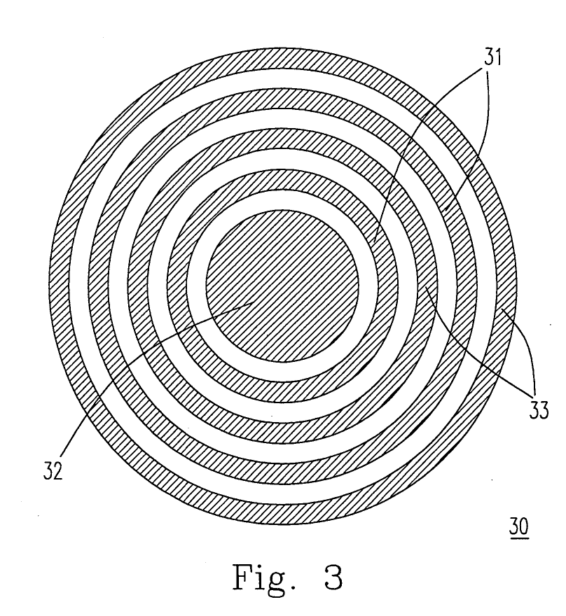

Please refer to the FIG. 3, which is a diagram in vertical view illustrating a third preferred embodiment of the proximity sensing device in the present invention. The proximity sensing device 30 demonstrated in FIG. 2(a) includes plural driving areas 31, an active sensing area 32 and plural restrictive sensing areas 33. The third preferred embodiment is an electric field type of the proximity sensing device, wherein the plural driving areas 31 are used for generating an electric field. When an electric field is generated by the plural driving areas 31, the active sensing area 32 and the plural restrictive sensing areas 33 both detect a fundamental voltage. When there is no operation provided, the active sensing area 32 and the plural restrictive sensing areas 33 detect the same electric voltage in magnitude. The active sensing area 32 is used for detecting an operation (a motion), and plural first voltage variations are generated therefrom. The plural restrictive sensing areas 33 are used for detecting the operation, and plural second voltage variations are generated therefrom. It is noted that the active sensing area 32 is regarded as the first sensing area and the plural restrictive sensing areas 33 are regarded as the plural second sensing areas, while the active sensing area 32 is regarded as the second sensing area and the plural restrictive sensing areas 33 are able to be regarded as the first sensing areas.

In the third preferred embodiment, essentially the active sensing area 32 is designed to detect the operation being a correct operation. In contrast, the plural restrictive sensing areas 33 are designed to detect the operation being a mistaken operation. It is repeatedly noted (as aforementioned) that the respective functions of the active sensing area 32 and the plural restrictive sensing areas 33 are possibly interchangeable with each other. That is, the active sensing area 32 can be altered to be used to generate the second voltage variation, namely to detect the mistaken operation, while the plural restrictive sensing areas 33 can be altered to be used to generate the first voltage variations, namely to detect the correct operation.

With respect to the distinguishing method, the default value of the threshold value, the relative location arrangement, the shapes of the plural driving areas 31, the active sensing area 32 and the plural restrictive sensing areas 33, and the detecting method adopted in the third preferred embodiment, all of the principles are identical to those described in the first preferred embodiment.

Comprehensively, the present invention possesses the following technical features: (1) the present proximity sensing device is able to be easily incorporated with all kinds of the known contact detectors or proximity detectors; (2) for every proximity sensing unit, it is allowed to deploy one or multiple sensing areas therein, or vice versa, multiple proximity sensing unit share one sensing area; (3) for every proximity sensing unit, it is allowed to deploy one or multiple restrictive sensing areas therein, or vice versa, multiple proximity sensing units share one restrictive sensing area; (4) the active sensing area and the restrictive sensing area are able to be designed in arbitrary shapes; (5) the sensing principle for the active sensing area which senses the operation is able to be in a way different from or identical to that of the restrictive sensing area; (6) multiple proximity sensing units are able to coexist simultaneously; (7) if the sensing principle of the restrictive sensing area is in a way different from the active sensing area, it is used for precluding the specific material from sensing; (8) the present proximity sensing device is highly feasible in all practical occasions. The device is simply fabricated by the printed circuit board programming or by the integrated circuit programming. The device is easily commercialized and massively produced.

In conclusion, the present invention is able to effectively recognize the mistaken operation and to adjust the sensitivity thereof based upon the circumstances. Therefore, the present invention substantially enhances the accuracy of the proximity sensing device.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims that are to be accorded with the broadest interpretation, so as to encompass all such modifications and similar structures. According, the invention is not limited by the disclosure, but instead its scope is to be determined entirely by reference to the following claims.

What is claimed is:

1. A proximity sensing device for judging an operation, comprising:
a first sensing area sensing the operation and generating a first signal; and
a second sensing area sensing the operation and generating a second signal, wherein
if a ratio of the first signal and the second signal is greater than a threshold, the operation is judged as a correct operation.

2. The device according to claim 1, wherein the threshold is adjustable.

3. The device according to claim 1, wherein the first sensing area and the second sensing area are adjacent to each other.

4. The device according to claim 1, wherein the first sensing area is surrounded by the second sensing area.

5. The device according to claim 1, wherein the second sensing area is surrounded by the first sensing area.

6. The device according to claim 1, wherein each of the first sensing area and the second sensing area is in a shape being one selected from a group of circle, rectangle, ellipse, star, heart and hollow-shape.

7. The device according to claim 1, wherein either of the first sensing area and the second sensing area senses the operation through one selected from a group of an electric field scheme, an electric resistance scheme, an electric capacitance scheme, a sound wave and an optic scheme.

8. The device according to claim 1, wherein the first sensing area senses the operation in a way different from that of the second sensing area.

9. A proximity sensing device for judging an operation, comprising:
a first sensing area and plural second sensing areas sensing the operation and generating a first signal and plural second signals respectively, wherein
if a ratio of the first signal and any one of the plural second signals is greater than a threshold, the operation is judged as a correct operation.

10. A proximity sensing method for judging whether an operation is a correct operation, comprising steps of:
generating a first signal in response to the operation;
generating a second signal in response to the operation; and
if a ratio of the first signal and the second signal is greater than a threshold, judging the operation as the correct operation.
